(19) United States
(12) Patent Application Publication
(10) Pub. No.: US 2007/0202482 A1
(43) Pub. Date: Aug. 30, 2007

(54) System and method for selecting and managing course materials with integrated distribution and sales of materials

(76) Inventors: Michael Mark, Athens, OH (US); Kerry Stoessel Pigman, Athens, OH (US); William Archer, Athens, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/362,558

(22) Filed: Feb. 24, 2006

(51) Int. Cl. G09B 3/00

(52) U.S. Cl. 434/350

(57) ABSTRACT

A system for selecting and managing course materials utilizes websites having faculty, administrator, and publisher services pages. The faculty services page is accessible by faculty members to adopt specific course materials for specific courses. The website includes an administrative services page which is accessible by administrators to input course information and to review the course materials adopted by the faculty members and a publisher services portal which is accessible by publishers to review purchase information related to course materials adopted by the faculty members. A student services website is accessible by students to purchase adopted course materials for specific courses.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to a system for selecting and managing course materials and, more particularly, to an Internet-based system for adopting, purchasing, and distributing text books and the like.

### BACKGROUND OF THE INVENTION

When an educational instructor makes a decision about what course materials will be used for a class, seminar, or on-line course, they must inform a variety of stakeholders so that the adopted course materials can be ordered from publishers or other distributors of such materials and be ready for the end-user on a timely basis. The instructor traditionally made such adoptions and transmitted those decisions in a variety of ways to an administrator or academic coordinator. More recently such adoptions may have been sent to the administrator via e-mail. The administrator or coordinator in turn must either order the course materials from the publisher or distributor for the appropriate number of students taking the course or be sure that the course information and institutional data be made available in association with the materials information so that distributors and or bookstores can collate all of the inter-related data. Where there are multiple vendors there is no assurance that the information is moving successfully from faculty to administration to vendors in an equally open manner as prescribed by law. Furthermore, suppliers of products such as publishers, have traditionally been omitted from the information gathering process, and had no way of knowing which of their products had been selected by faculty members, as they had to request and gather such data from multiple sources, who traditionally have not been forthcoming with that information.

Once the course material and book information is obtained and circulated to appropriate retail vendors, there exists a time period during which changes to the institutional data may occur, or changes may be made to the original selection of course materials. Such changes must be conveyed back to the retail vendors so that they may address excess course materials, returns of course materials etc. This process can be extremely time consuming and expensive for all involved. These revisions become particularly onerous for a college or university having hundreds or perhaps thousands of courses for which appropriate course materials must be obtained and distributed to the students in a timely fashion. This is further complicated in distance learning programs where the students are not located at one campus or one facility.

This prior process is further complicated by the fact there are an increasing number of third party providers available via the Internet where students can obtain course materials such as textbooks thus making it increasingly difficult to predict how many course materials should be ordered. Accordingly, there is a need in the art for an improved system and method for selecting and managing course materials.

### SUMMARY OF THE INVENTION

The present invention provides a system and method for selecting and managing course materials which overcomes at least some of the above-noted problems of the related art. According to the present invention, a system for managing course materials comprising, in combination, a website having a faculty services page and a student services page. The faculty services page is accessible by faculty members to adopt specific course materials for specific courses. The student services page is accessible by students to purchase adopted course materials for specific courses.

According to another aspect of the present invention, a system for selecting and managing course materials comprises, in combination, at least one website having a faculty services page, an administrator services page, a publisher services portal; and a student services page. The faculty services page is accessible by faculty members to adopt specific ISBN items and non-ISBN items for specific courses. The administrative services page is accessible by administrators to input course information and to review the course materials adopted by the faculty members. The administrative services page enables administrators to release course adoption information to vendors. The publisher services portal is accessible by publishers to review purchase information related to course materials adopted by the faculty members. The student services page is accessible by students to locate vendors for purchasing adopted course materials for specific courses.

According to yet another aspect of the present invention, a method for selecting and managing course materials comprises steps of, in combination, providing at least one website having a faculty services page, an administrator services page, and a publisher services portal. The faculty services page is accessible by faculty members to adopt specific course materials for specific courses. The administrative services page is accessible by administrators to input course information and to review the course materials adopted by the faculty members. The publisher services portal is accessible by publishers to review purchase information related to course materials adopted by the faculty members

From the foregoing disclosure and the following more detailed description of various preferred embodiments it will be apparent to those skilled in the art that the present invention provides a significant advance in the technology of course material management systems. Particularly significant in this regard is the potential the invention affords for providing a high quality, reliable, simple, and relatively low cost, open system with improved operational performance with no unique advantages to any one commercial outlet. The invention provides the faculty, the institutions, the administrators, the publishers, and the commercial outlets one transparent set of Internet tools that assist in the process of knowing what books and materials are for what courses, in what locations. The tools can be advantageous as well in providing the necessary information described above, in a variety of academic time-sets, i.e. quarter systems, semester systems, self paced programs, cohort programs, workshops, conferences etc. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a schematic view of a course material management system according to a preferred embodiment of the present invention;

FIG. 2 is a schematic view of the course material management system of FIG. 1, wherein functionality of an administrative services page is illustrated;

FIG. 3 is a schematic view of the course material management system of FIGS. 1 and 2, wherein functionality of an administrator page is illustrated;

FIG. 4 is a schematic view of the course material management system of FIGS. 1 to 3, wherein functionality of two different voucher models is illustrated, along with the ability to view reports online or download invoices to the user's system;

FIG. 5 is a schematic view of the course material management system of FIGS. 1 to 4, wherein functionality of a financial assistance model and the means to import those orders is illustrated;

FIG. 6 is a schematic view of the course material management system of FIGS. 1 to 5, wherein functionality of a faculty services is illustrated;

FIG. 7 is a schematic view of the course material management system of FIGS. 1 to 6, wherein functionality of a faculty specific login page is illustrated;

FIG. 8 is a schematic view of the course material management system of FIGS. 1 to 7, wherein functionality of a faculty generic logon page is illustrated;

FIG. 9 is a schematic view of the course material management system of FIGS. 1 to 8, wherein functionality of a faculty coordinator page is illustrated;

FIG. 10 is a schematic view of the course material management system of FIGS. 1 to 9, wherein functionality of an individual order page is illustrated;

FIG. 11 is a schematic view of the course material management system of FIGS. 1 to 10, wherein functionality of an institution bulk order page is illustrated;

FIG. 12 is a schematic view of the course material management system of FIGS. 1 to 11, wherein functionality of a student page is illustrated;

FIG. 13 is a schematic view of the course material management system of FIGS. 1 to 12, wherein functionality of a student services page is illustrated;

FIG. 14 is a schematic view of the course material management system of FIGS. 1 to 13, wherein functionality of a student shopping mall page is illustrated;

FIG. 15 is a schematic view of the course material management system of FIGS. 1 to 14, wherein functionality of a student buyback page is illustrated;

FIG. 16 is a schematic view of the course material management system of FIGS. 1 to 15, wherein functionality of a publisher page is illustrated;

FIG. 17 is a schematic view of the course material management system of FIGS. 1 to 16, wherein additional functionality of the publisher page is illustrated; and

FIG. 18 is a schematic view of the course material management system of FIGS. 1 to 17, wherein additional functionality of the publisher page is illustrated.

It should be understood that the appended drawings present a somewhat simplified representation of various preferred features illustrative of the basic principles of the invention. The specific design features of the course material management system as disclosed herein, including, for example, specific functionality will be determined in part by the particular intended application and use environment.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved course material management system disclosed herein. The following detailed discussion of various alternative and preferred embodiments will illustrate the general principles of the invention with reference to managing university and/or corporate courses, seminars, simulations and the like. Other embodiments suitable for other applications will be apparent to those skilled in the art given the benefit of this disclosure.

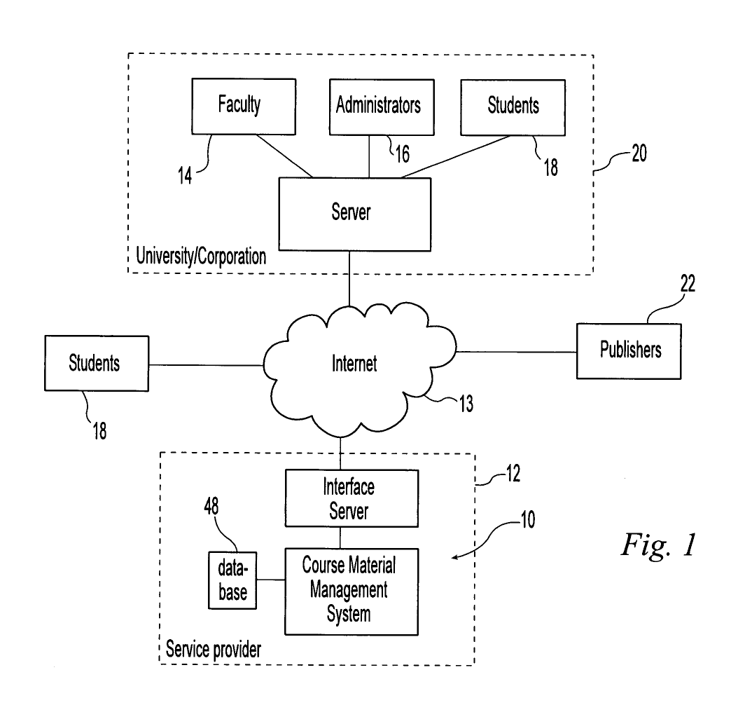

Referring now to the drawings, FIG. 1 illustrates a course material management system 10 according to a preferred embodiment of the present invention. The illustrated course material management system is operated by a service provider 12 and is accessed via the Internet 13 by faculty 14, administrators 16, and students 18 of a university or corporation 20 offering courses, seminars, simulations and the like and is also accessed by publishers 22 of course materials. While the illustrated system 10 is accessed via the Internet 13, it is noted that the system can alternatively be accessed in any other suitable manner. It is also noted that while the illustration shows a single one of each of the individuals accessing the system 10, typically there is a large quantity of each that are accessing the system 10.

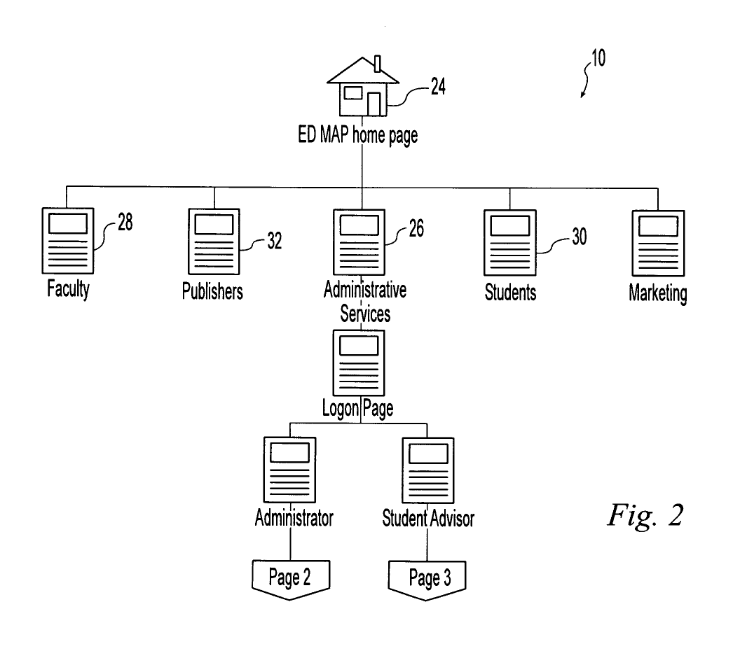

FIG. 2 illustrates the course material management system 10. The illustrated course management system 10 includes a website 24 or series of web pages or web sites that is accessed by the faculty 14, administrators 16, students 18, publishers 22, and others via the Internet 13. The illustrated system 10 includes an administrative services page 26 that can be accessed by the administrators 16, a faculty services page 28 that can be accessed by the faculty 14, a student website 30 that can be accessed by the students 18, and a publisher's page or portal 32 that can be accessed by the publishers 22 and other academic vendors. The pages 26, 28, 30, 32 are accessed through the use of usernames and passwords but any other suitable means of limited access to desired individuals or entities can be utilized.

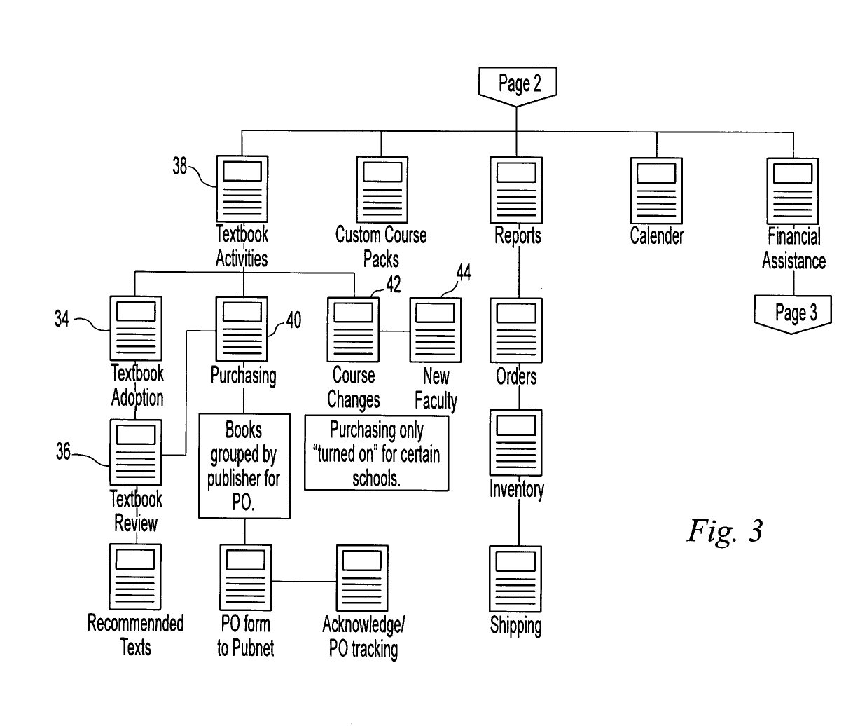

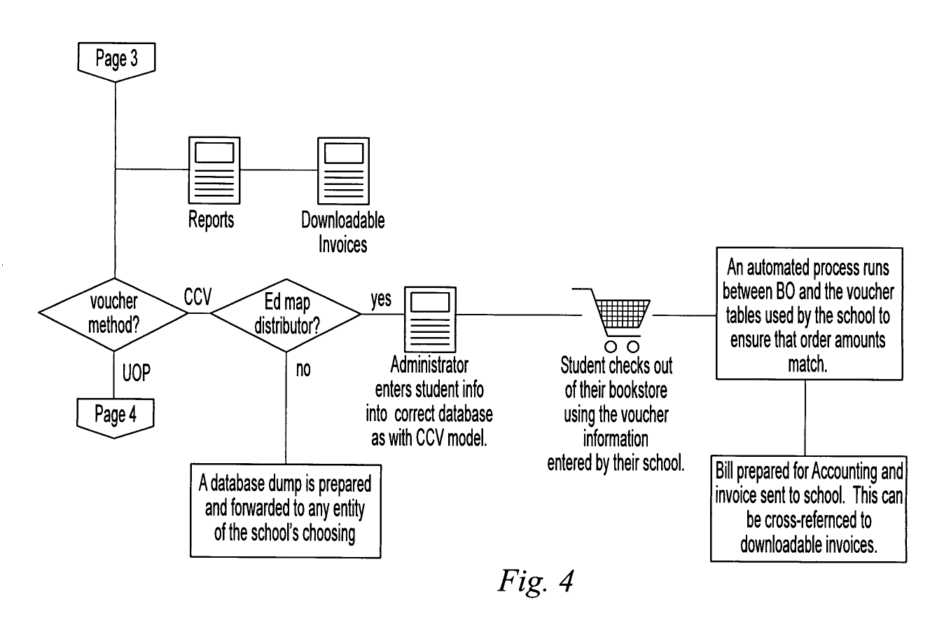

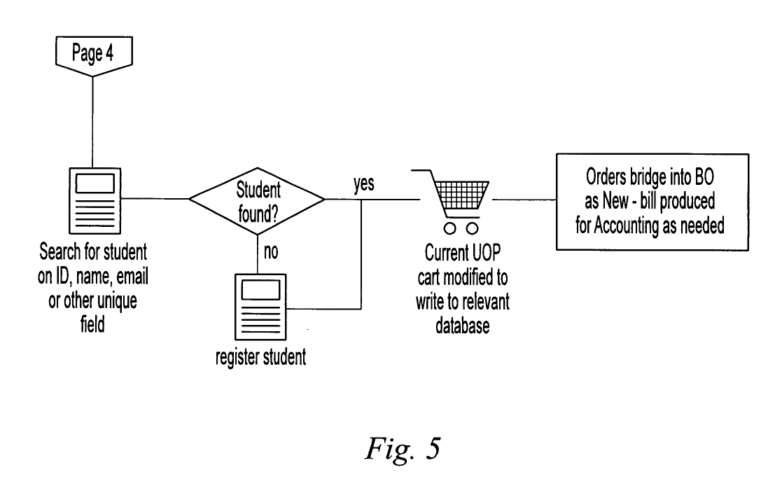

As best shown in FIGS. 2 to 5, the administrative services page 26 provides the functionality of textbook adoption, textbook review, process management, course changes, group ordering, and other features. On a textbook adoption page 34, administrators 16 who are responsible for the transmission of this data have the ability to adopt text books for courses where faculty 14 can not or will not perform that function on their own. The adoption functionality is the same as that of the faculty page 28 which is described in more detail hereinafter. A textbook review page 36 allows administrators 16 to review all textbooks that have been adopted by the faculty 14 at their institution 20, see those instances where faculty 14 have failed to adopt material in a timely manner, and see where invalid data has been entered. Line items may be modified or even deleted when necessary. Since some institutions 20 may be adopting books for hundreds or thousands of courses at a time, buttons at the top of the page 36 search for courses for which there are no adopted textbooks or with obviously wrong ISBN's. This allows the administrator 16 to identify faculty 14 who have not participated or faculty 14 who have made input errors, respectively. When the administrator 16 has reviewed all adoptions, a link on the left side of the page 36 allows them to notify the management service provider 12 that the adoption process is complete and the courses and adopted textbooks can be imported into the management service provider's system 10.

In addition to the textbook adoption process described above that are relevant to the administrator 16, the administrative portal 26 also provides access to a Microsoft SQL Server database of the service provider 12 that enables administrators 16 to run real-time searches for orders, inventory levels and shipping information. The searches include: (1) order search by name, period and course, as well as credits and returns; (2) inventory search by specific assigned location, ISBN, and course; (3) shipping search by name, period and course (UPS tracking numbers are links that return tracking information from UPS servers). The Administrative services page 26 also allows administrators to add, modify, or delete a course at any time before registration begins.

When the administrative services page 26 is adapted for use by educational institutions 20 that bundle textbooks in the cost of tuition, a separate student storefront is not needed. This system allows an institution 20 to either directly input student orders or provide opportunities for data exchanges so that orders approved by the institution 20 can be shipped to the students 18 and billed directly to the accounting database of the educational entity 20. Such electronic data exchange facilitates the billing and payment process between the institution 20 and the vendor 22.

The administrative services pages 26 preferably provide the following services: (1) textbook adoption activities; (2) management reports; (3) order/creation of custom coarse packs; (4) enhancement of financial aid services and billing processes; (5) release of desk copies; and (6) group (cohort) ordering. Student advisors, also considered administrators 16, can also use the administrative services page 26 because administrator functionality is logon specific. The service provider 12 can provide a range of different services to institutions 20. As each institution 20 becomes a client of the service provider 12, the service provider 12 accesses logon tables through a custom GUI, selecting specific services that are needed by that school 20. As a service is selected, the relevant link on the administrative services page 26 becomes enabled. Some services may be further enabled by sub-selections, giving further “drill down” capability. Administrator logon tables are constructed with the expectation that multiple access levels will be in place—student advisers will never be able to involve themselves with adoption activities or releasing desk copies.

Textbook activities page 38 is sub-divided into five areas (textbook adoption 34, textbook review 36, textbook purchasing 40, course changes 42, and entering new faculty 44) each of which is discussed in more detail herein. Each of these areas is displayed along a tab along the top or side of the administrative services page 26.

The textbook adoption form 34 has five tabs (adopt textbooks and non-ISBN items (the default), request desk copies, research book database, previous adoptions and recommended texts) across the top or side of the page. Administrators 16 can use the tabs much the same way as faculty 14 do. For administrators 16, however, the course dropdown is not logon specific to the individual administrator 16 because there may be multiple administrators 16 at a school 20 all using the same logon information to gain access to the various tools. Once a course has been selected, relevant fields populate with information. The book database should be scanned to confirm availability of the selected textbooks. When a textbook is no longer available or is being replaced with a new edition (which means there is a new ISBN) it is clearly identified to the administrator in order to prevent confusion. If an ISBN is manually entered and not found within the BTOL database, a message is presented to the instructor letting them know that there is potentially a problem so that they can verify and/or correct the ISBN. The ISBN field is a free-form text field that can be populated by the administrator. As the ISBN is entered into its field, it is checked for formatting and other errors. When the ISBN is found in the book database, author, publisher, title, and other information is automatically written into their respective fields on the form.

Administrators 16 may also use the textbook adoption tab to adopt a non-ISBN item such as, software, custom coarse packs, class appropriate equipment, or supplemental material. In such cases, a tab at the top of the textbook adoption page 34 allows the administrator 16 to clearly identify the item so that the service provider 12 can source the item. This information is saved at the service provider 12 along with course name and number.

Administrators 16 use the request desk copies tab to ask for a personal desk copy from a publisher 22 on behalf of a faculty member 14. How this is handled depends on several factors such as whether or not there is a specific publisher representative for that institution 20. If there is, the service provider 12 matches the request to the appropriate individual within the publisher representative table and sends an email request from this tab of the form. This is a request to the publisher 20 from the administrator 16 on behalf of a faculty member 14. The publisher representative will determine whether or not the book should be provided based upon and among other factors such as adoption or likelihood of adoption which can be gleaned from this system 10 as well. In such cases, the service provider 12 is facilitating this interaction, rather than being held responsible by the administrator 16 or the publisher 22 for delivery of the item. The administrator/faculty name, email and book information can automatically populate relevant fields, but shipping information should consist of free-form fields that need to be filled out by the administrator. There will be a large comment box that allows faculty members 14 to ask questions as appropriate.

Administrators 16 use the research book database tab to search directly against the book database. Users will run searches by the ISBN, title, or discipline (such as math books). As a book is selected, the user is able to see the jacket (cover of the book) as well as the table of contents for selected items. A button on this review page writes pertinent information to the adoption form when it is clicked and the users automatically return to the adoption form. The adoption form is reviewed for accuracy and then it can be submitted to the database. This process is repeated as often as necessary until the user has adopted all required books for each course. This process will eliminate one of the most significant problems in the textbook adoption process, and that is the “ambiguity” of the book being requested as all relevant data is being drawn out of the standardized database. No longer will faculty 14 and administrators 16 be entering ten digit ISBN numbers, nor requesting “same as last time”, or most recent addition. Instead they will be selecting specific titles from a comprehensive database which is writing data in to the adoption form.

Administrators 16 may use the recommended texts tab if the school has a list of recommended texts for certain classes or as a site for publisher recommendations. When used, the instructor 14 will see a pop-up when they select a course, letting them know which book they should be adopting if there is an institutional list, or publisher recommendations when appropriate. Where there is only one choice and has been established by a centralized curriculum committee, that information automatically populates the adoption page 34. Where there are multiple choices, the instructor 14 selects the desired textbook from a list, causing all textbook information to be written into the adoption form 34 thus eliminating the need to re-key information, and of course obtaining the most current information from publisher reps. If a school 20 has not recommended any specific items for the course and publisher reps have made no recommendation, then as with the faculty pages 28, the recommended texts tab has a button allowing administrators 16 to review comments made by other instructors 14 regarding textbooks that have been found to be useful. It may be that no comments have been made for certain disciplines, but this opportunity to present other faculty comments, can provide another level (peer review) of assurance that a textbook has been found to have a certain degree of merit by comparable users.

The textbook review page 36 enables the administrator 16 to review, delete, modify and present all relevant textbook and course material data. This may be a review or change effected by the administrator 16, or may mean the presentation of coarse material data to appropriate educational vendors for review and/or stocking purposes. The software can run a search against the book database to check for invalid ISBNs, or reject invalid ISBN inputs where fewer than ten characters have been used. Where an adopted item does not occur in the book database, it is often because of an input error, however, there may be items that do not match because they have not been added to the book database. These items can be flagged, not necessarily treating them as errors, but altering administrators to the fact that there has been an adoption of an ISBN that may be flawed. The administrator 16 can also check for un-adopted courses. Clicking this button returns all courses that have not yet had an entry inserted into the adopted book table. Preferably, the administrator 16 can generate a bulk email to delinquent faculty 14.

The purchasing page 40 enables the administrator 16 to release the course adoption information to vendors with the click of a button. This page 40 can be reached from two different directions—the main textbook activities page 38 and from within the textbook review page 36.

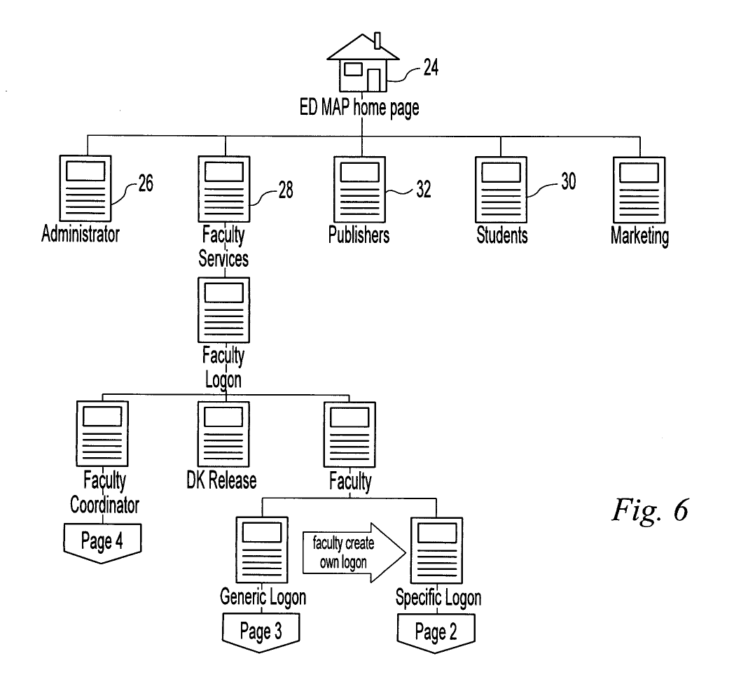

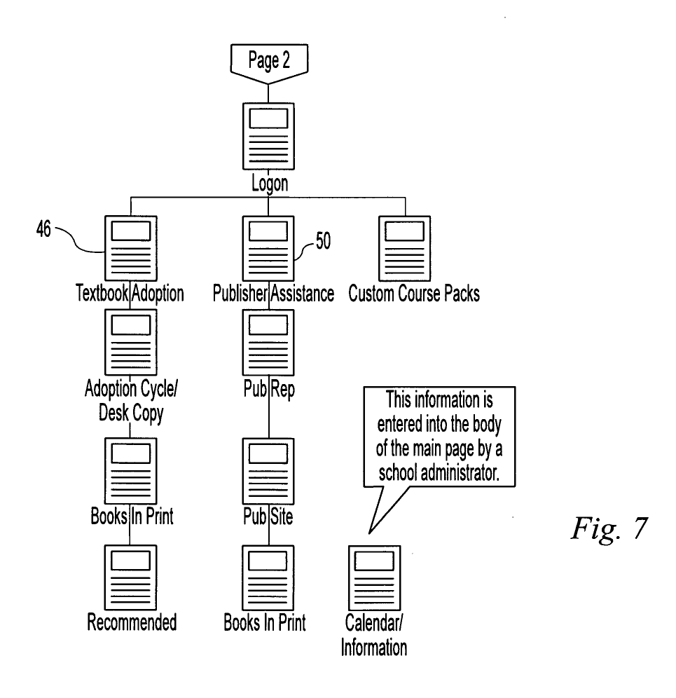

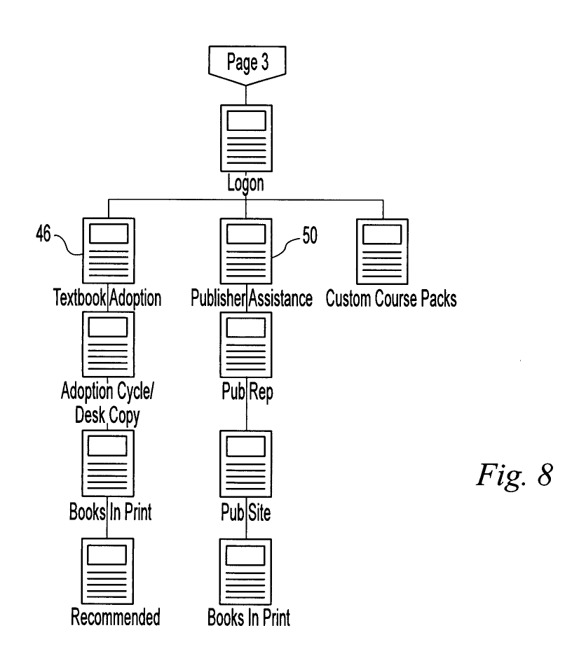

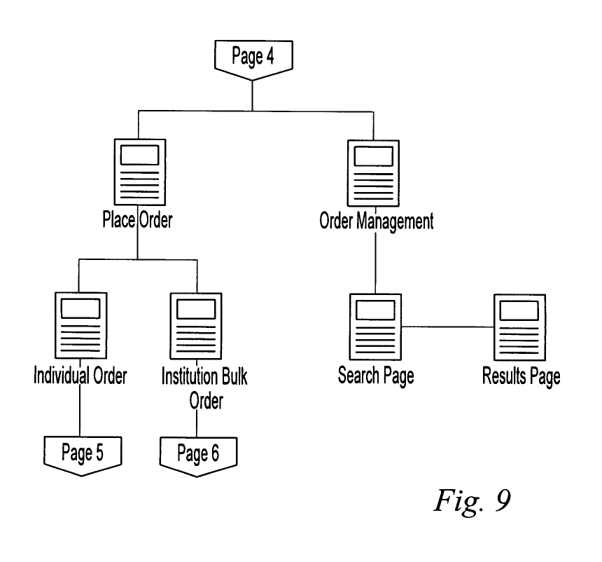

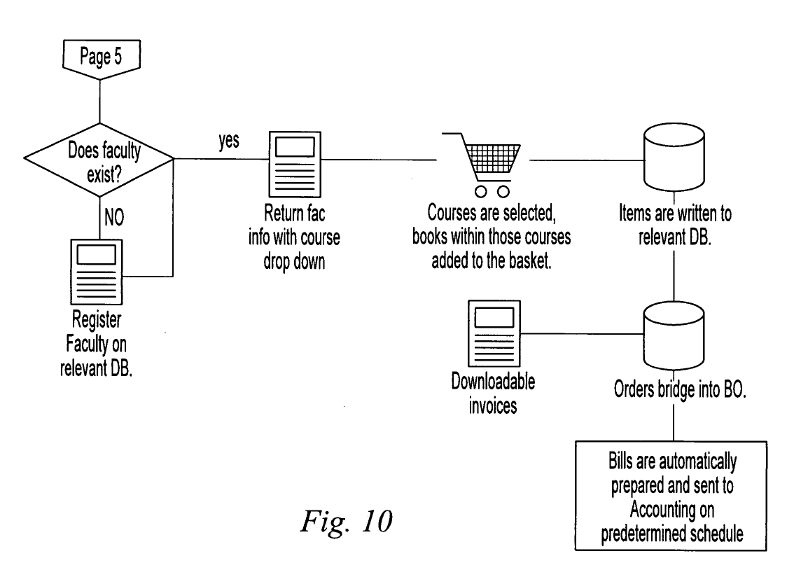

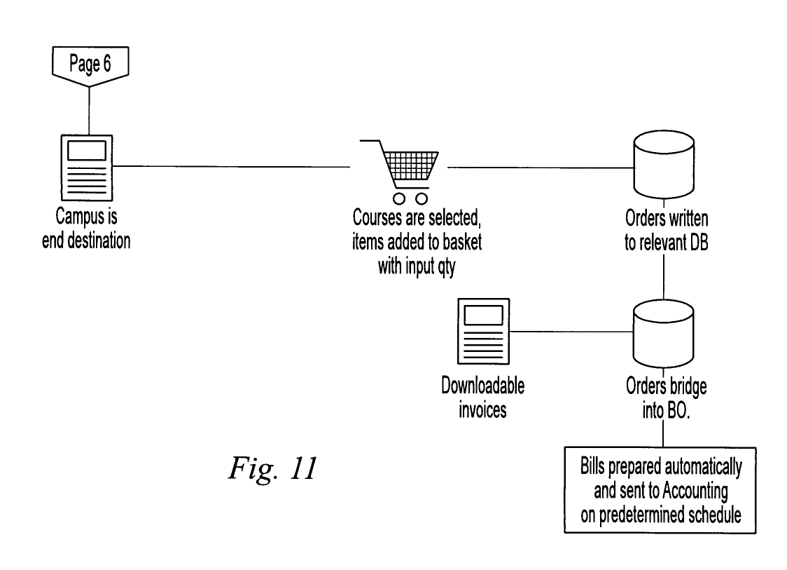

As best shown in FIGS. 6 to 11, the faculty services page 28 provides the functionality of textbook adoption, publisher assistance, and other features. The textbook adoption page 46 allows the faculty 14 to adopt textbooks that they want to use for upcoming semesters. Each institution 20 passes a data dump of course and instructor information. Once imported into the service provider database 48, this information can be used to automatically populate the adoption forms. The instructor 14 adds the selected ISBN and other book-specific information before writing the form to the adoption table. The publisher assistance page 50 provides a series of links to institution-specific publisher representatives as well as to publisher web sites. When requested, a publisher representative will assist the faculty member 14 by informing them of new books available for particular disciplines, course packs, and custom titles and so on. When a representative is not available, the link to the publisher websites allows the faculty members 14 to do research as necessary.

Each school 20 can give faculty members 14 a generic logon to the faculty services page 28 or alternatively faculty 14 can create their own logon information. Having individual logon information enables them to have access to historical order placement information that is specific to the courses they will be teaching and so on. There can be two different methods used for faculty registration. This is important for calendar and other functionality. The first option is to give the service provider 12 a data dump of instructors that includes first name, last name, faculty ID, and email address. School location code is automatically assigned to ensure that faculty members 14 at different schools 20 with the same name or user ID cannot be confused. This information is entered into a logon page specifically used for the faculty pages. A generic password can be created for each user that will need to be changed the first time a user logs on, to ensure the maximum degree of privacy. The second option is a “hidden option” offered only to schools 20 that are unable to provide a data dump because of limited technology or because of privacy issues that prevent the school 20 from being able to share personal information pertaining to staff members. For a limited period of time, faculty members 14 are able to log into the site using a generic username and password provided to them by the school. They then must register themselves. Recognizing the generic ID will allow the service provider 12 to assign the correct location (school code) to each user as they register. The same information is collected as in the first option. From time to time, the administrators 16 need to review the list of registered faculty 14 to remove those who have left the institution 20. This prevents access to the site 26 by individuals who may have been terminated by the school 20. This is also in the best interest of the school 20 if the service provider 12 charges licensing fees on a per-user basis.

Upon entering the faculty main page, there are informational panels to display dates and other primary information. This information is entered by the school administrator 16, written to the database, and retrieved upon login by faculty 14.

The textbook adoption form 46 has five tabs (adopt ISBN and non-ISBN items, request desk copies, research book database, and recommended texts) across the top or side of the page. An instructor 14 may choose to adopt multiple textbooks for any one course. An instructor 14 who may be assigned to teach the same course semester after semester and has previously used the system 10 before for textbook adoption has the option to perform a quick adoption. This feature allows the instructor 14 to select the specific course and simply populate it with the books that were previously used. In such circumstances, the book database should still be scanned to confirm availability of the selected books. Where one is no longer available or is being replaced with a new addition (which means there is a new ISBN) this is clearly identified to the instructor 14, preventing confusion. If an ISBN has been manually entered and is not found in the database, a message is presented to the instructor, letting them know that there is a potential problem so that they can verify and/or correct the ISBN.

The ISBN field is a free-form text field that is populated by the instructor 14. After the ISBN is entered into its field, it is checked for formatting and other errors. When the ISBN is found in the book database, author, publisher, title, and other information is automatically written into their respective fields on the form. If a form has been populated with information from a recommended list and yet the instructor has deliberately chosen to use a different item, that decision is flagged for review by school administrators 16.

Instructors 14 may use the adoption tab to adopt a non-ISBN item such as, a stethoscope for a medical course, a template for a drafting class or tools for computer classes. In such cases, a tab at the top of the textbook adoption page allows the instructor 14 to clearly identify the item so that the service provider 12 can source the item. This information is saved at the service provider 12 along with course name and number. This functionality allows the school administrator 16 to verify that all instructors 14 have adopted course materials, books, or clearly stated that no course materials are required, for all courses.

Instructors 14 use the request desk copies tab to ask for a personal desk copy. How this is handled depends on several factors such as whether or not there is a specific publisher representative for that institution 20. If there is, the service provider 12 matches the publisher 22 within the book table to the publisher representative table and send an email from this tab of the form. This is a request to the publisher 22 from the administrator 16. The publisher representative will determine whether or not the book should be provided. In such cases, the service provider 12 is simply facilitating this interaction, rather than being held responsible by the administrator 16 or the publisher 22 for delivery of the item. The Instructor's name, email and book information can automatically populate relevant fields, but shipping information should consist of free-form fields that need to be filled out by the instructor. There will also be a large comment box that allows faculty members 14 to ask questions as necessary. Where the service provider 12 does not have specific publisher representative email addresses, the service provider 12 can attempt to collect the pertinent information and forward the requests on to the publisher representative when identified.

Instructors 14 will use the research book database tab to search directly against the book database. Users will run searches by the ISBN, title, or discipline (such as math books). As a book is selected, the user is able to see the jacket (cover of the book) as well as the table of contents. A button on this review page writes pertinent information to the adoption form when it is clicked and the users automatically return to the adoption form. The adoption form is reviewed for accuracy and then it can be submitted to the database. This process is repeated as often as necessary until the user 14 has adopted all required books for each course.

If the school 20 has a list of recommended texts for certain classes, the instructor 14 will see the Recommended Text tab appear, letting them know which book they should be adopting. Where there are multiple choices, the instructor 14 selects the desired textbook from a list, causing all textbook information to be written into the adoption form. Thus eliminating the need to re-key information. If the school has not recommended any specific items for the course, the Recommended Text tab has a button allowing instructors 14 to review comments made by other instructors 14 regarding textbooks that have been found to be useful. It may be that no comments have been made for certain disciplines, but this can provide another level (peer review) of assurance that a textbook has been found to have a certain degree of merit by other users. Alternatively, this recommended text button may be used by publishers 22 to promote specific titles for appropriate courses.

Some institutions 20 elect to have staff members, known as faculty coordinators, place orders for desk copies on behalf of faculty members 14. This gives the institution 20 a sense of greater control over which books are received by instructors 14. Thus the logon page used by different faculty members 14 can grant access to levels that have different functionality.

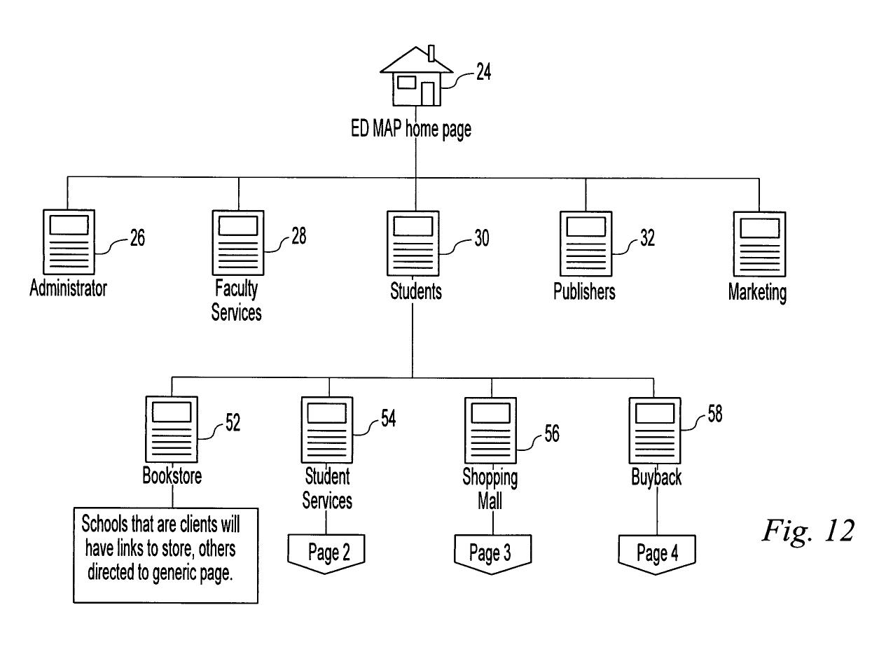

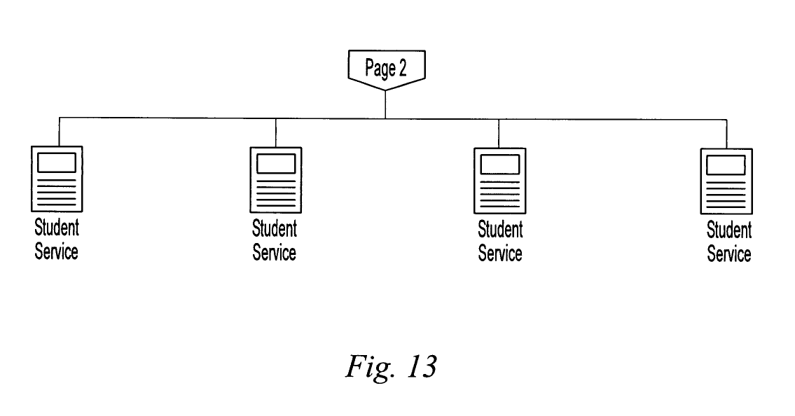

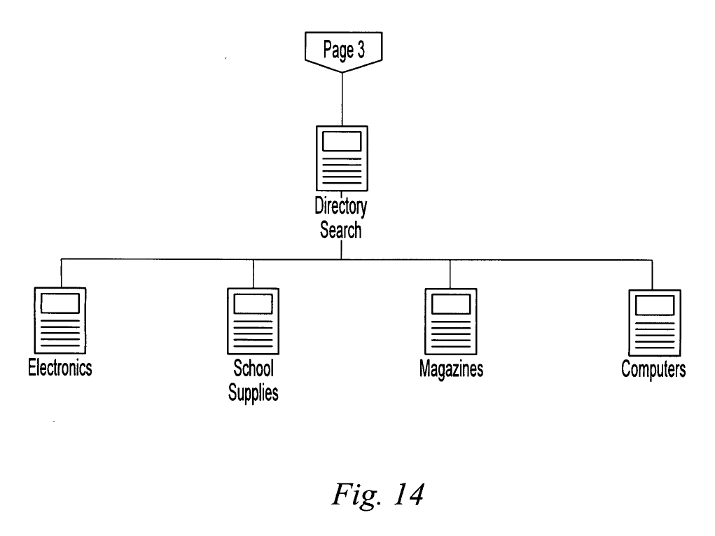

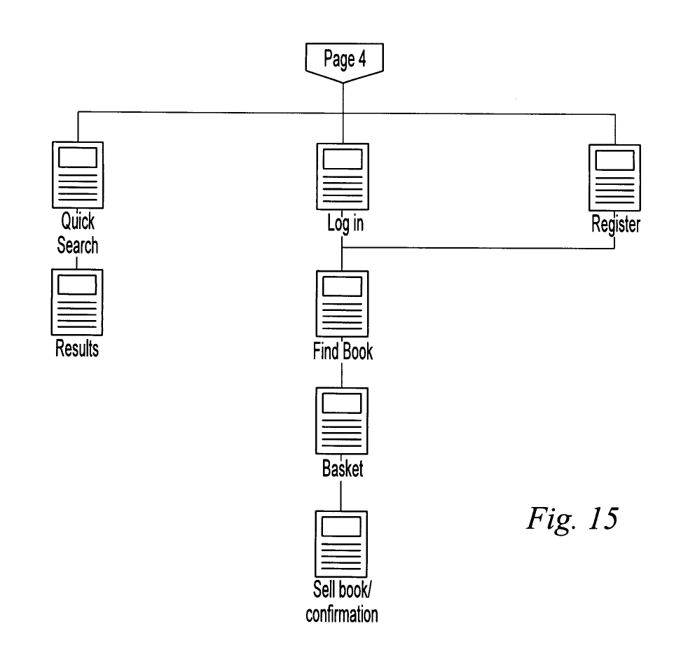

As best shown in FIGS. 12 to 15, the student services page 30 provides the functionality of bookstore locator 52, student services 54, shopping mall 56, textbook buyback 58, and other features. The bookstore locator 52 enables students 18 to locate the bookstore that is designated and branded as the official online bookstore for the institution 20. The student services page 30 provides a downloadable order form that can be mailed or faxed. This page 30 also contains a link that allows students 18 to research order status and tracking information. The shopping mall page 56 provides links to various company websites with which the service provider 12 has formed partnerships. A main directory search combined with a series of tabs allows users to jump to specific areas such as, for example, electronics, school supplies, magazines, and computers. The buyback page 58 enables students to search a database for pricing on textbooks that will be purchased by the service provider 12 or other used book distributor that may be used by other students or institutions.

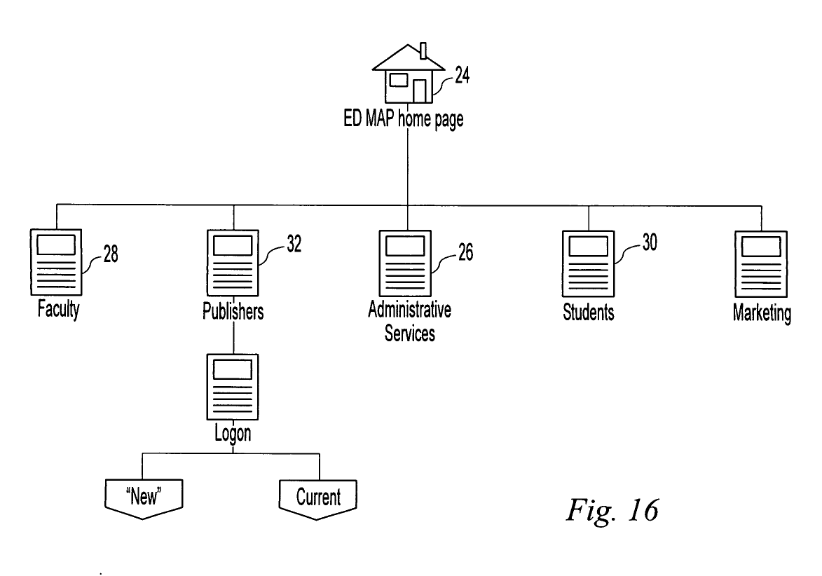

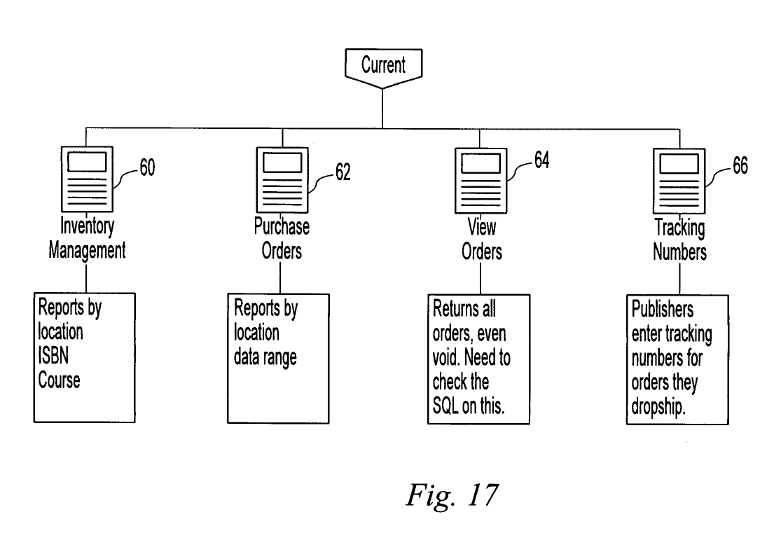

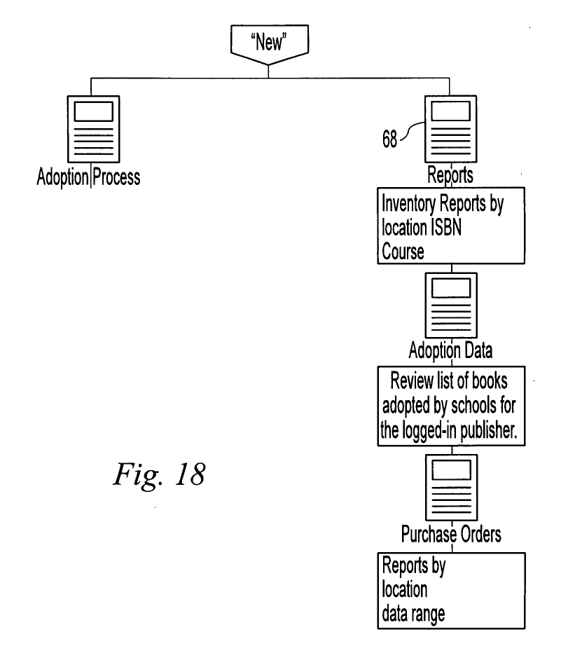

As best shown in FIGS. 16 to 18, the publisher services page 32 provides the functionality of inventory management 60, purchase orders 62, view orders 64, tracking numbers 66, reports 68, and other functions. The reports page 68 enables publishers 22 to get an emailed list of all textbooks adopted at a school 20 for which they are the publishers. This report can include the email addresses of faculty members 14 so that the publisher 22 can directly contact them and suggest other items.

From the foregoing disclosure and detailed description, it is apparent that the system of the present invention provides an improved system and method of selecting and managing course materials. For example, the invention provides a system for managing course materials for a combination of website services pages for faculty, students, administrators and publishers. The faculty page enables faculty members to adopt specific course materials for specific courses. The student page enables students to purchase and/or locate vendors for specific course materials The administrative page allows for the integration of institutional information with the adoption information for presentation to bookstores, distributors and other outlets of commerce for the end user (peer to peer exchange programs, national book websites, or other retail outlets). An lastly a vendor portal is available so that those selling products to the market can view the various segments doing the purchasing and subsequently monitor that adequate stock is available and moving to the specific market.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A system for selecting and managing course materials comprises, in combination:
at least one website having a faculty services page, an administrator services page, and a publisher services portal;
wherein the faculty services page is accessible by faculty members to adopt specific course materials for specific courses;
wherein the administrative services page is accessible by administrators to input course information and to review the course materials adopted by the faculty members; and
wherein the publisher services portal is accessible by publishers to review purchase information related to course materials adopted by the faculty members.

2. The system according to claim 1, wherein the websites have a student services page that is accessible by students to locate vendors for purchasing adopted course materials for specific courses.

3. The system according to claim 2, wherein the student services page enables the students to sell used course materials.

4. The system according to claim 2, wherein the student services page enables the students to locate vendors for purchasing goods other than the adopted course materials.

5. The system according to claim 2, wherein the student services page enables the students to locate vendors for purchasing goods other than the adopted course materials.

6. The system according to claim 1, wherein the publisher services portal enables publisher to obtain a list of textbooks adopted at a school.

7. The system according to claim 1, wherein the faculty services page provides links to at least one of publisher representatives and publisher websites.

8. The system according to claim 1, wherein the faculty services page permits faculty to automatically populate adoption forms with textbooks previously used.

9. The system according to claim 1, wherein the faculty services page provides a course specific recommended textbook list.

10. The system according to claim 9, wherein selections from the recommended textbook list automatically populate a textbook adoption form.

11. The system according to claim 1, wherein the faculty services page enables faculty to adopt non-ISBN items.

12. The system according to claim 1, wherein the faculty services page enables faculty to request desk copies.

13. The system according to claim 1, wherein the faculty services page enables faculty to search for textbooks in a book database.

14. The system according to claim 13, wherein information selected from the book database can automatically populate a textbook adoption form.

15. The system according to claim 1, wherein the administrative services page enables administrators to verify that all faculty have adopted course materials.

16. The system according to claim 1, wherein the administrative services page enables administrators to review and modify faculty course material adoptions.

17. The system according to claim 1, wherein the administrative services page enables administrators to release course adoption information to vendors.

18. The system according to claim 1, wherein the administrative services page enables administrators to generate a bulk email to all faculty who have not made an adoption.

19. A system for selecting and managing course materials comprises, in combination:
at least one website having a faculty services page, an administrator services page, a publisher services portal; and a student services page;
wherein the faculty services page is accessible by faculty members to adopt specific ISBN items and non-ISBN items for specific courses;
wherein the administrative services page is accessible by administrators to input course information and to review the course materials adopted by the faculty members;
wherein the administrative services page enables administrators to release course adoption information to vendors; and
wherein the publisher services portal is accessible by publishers to review purchase information related to course materials adopted by the faculty members; and
wherein the student services page is accessible by students to locate vendors for purchasing adopted course materials for specific courses.

20. A method for selecting and managing course materials comprises steps of, in combination:
providing at least one website having a faculty services page, an administrator services page, and a publisher services portal;
wherein the faculty services page is accessible by faculty members to adopt specific course materials for specific courses;
wherein the administrative services page is accessible by administrators to input course information and to review the course materials adopted by the faculty members; and
wherein the publisher services portal is accessible by publishers to review purchase information related to course materials adopted by the faculty members.
